(19) United States
(12) Patent Application Publication
(10) Pub. No.: US 2026/0329112 A1
(43) Pub. Date: Oct. 22, 2026

(54) LENS ELEMENT WITH OPTIMIZED MICROLENSES FOR ABNORMAL REFRACTION CONTROL

(71) Applicant: Essilor International, Charenton-Le-Pont (FR)

(72) Inventors: Matthieu GUILLOT, Charenton-Le-Pont (FR); Bruno FERMIGIER, Charenton-Le-Pont (FR); Marius PELOUX, Charenton-Le-Pont (FR)

(73) Assignee: Essilor International, Charenton-Le-Pont (FR)

(21) Appl. No.: 19/486,418

(22) PCT Filed: Feb. 21, 2025
(86) PCT No.: PCT/EP2025/054735

§ 371 Date: Nov. 21, 2025

(30) Foreign Application Priority Data
Mar. 6, 2024 (EP) 24305344.4

(51) Int. Cl. G02C 7/02

(52) U.S. Cl. CPC G02C 7/022; G02C 2202/16; G02C 2202/24

(57) ABSTRACT

A lens element intended to be worn in front of an eye of a wearer, the lens element comprising: a holder, and a plurality of optical elements superimposed on the holder, each optical element providing simultaneously a first optical function based on a prescription of the wearer for correcting an abnormal refraction of said eye and a second optical function of not focusing an image on the retina of said eye, characterized in that each optical element comprises a central area and a plurality of outer areas surrounding the central area, wherein the maximal height of the central area is smaller than the maximal height of the outer areas

### TECHNICAL FIELD

The disclosure relates to lens element for controlling an abnormal refraction of an eye, and more particularly to an optical element comprising optical elements for correcting and slowing down the progression of an abnormal refraction of an eye.

### BACKGROUND

In recent years, there has been a rise in the development of solutions aimed at controlling the progression of abnormal refraction in the eye, such as myopia. One of the most promising solutions proposes to create a defocus in front of the retina that generates a myopia stop signal controlling the elongation of the eye and slowing down the progression of myopia. These new myopia control lenses consist of lenses comprising microlenses that refract part of the light in front and/or behind of the retina of the eye of the wearer.

Recent controlled clinical trials provided evidence of the benefit of peripheral optical microstructure to slow down the progression of an abnormal refraction if the lens element is worn for a sufficient time per day by the wearers-usually children (Bao, Yang, Huang, Li, Pan, Ding, Lim, Zheng, Spiegel, Drobe, Lu, Chen. One-year myopia control efficacy of spectacle lenses with aspherical lenslets. British Journal of Ophthalmology, 2021, 0, 1-6). In normal, straight viewing conditions, children using spectacle lenses with optical microstructure in the periphery will look through a central clear zone, which has no impact on visual performance. However, eye movements and possible position shifts of the spectacle frame make it possible that the visual axis passes through the optical microstructure. In such case, the reduced visual performance may negatively affect the wearing time thus limiting the benefit of the lens.

Depending on the importance of the progression of the abnormal refraction of the eye, it may be necessary to improve the signal controlling the progression of the abnormal refraction. However, improving the control signal, for example by improving the defocus in front and/or behind the retina tends to negatively impact the visual acuity and the visual comfort of the wearer.

Thus, while diverse solutions to correct different visual impairments have proved to be of great benefits, they have shown to be also accompanied by drawbacks such as a reduction of the visual comfort of the wearer.

Therefore, there is a need to provide lens elements with optimized visual acuity or visual comfort, and optimized control of the progression of the abnormal refraction of the eye of the wearer.

### SUMMARY

To this end, the disclosure proposes a lens element intended to be worn in front of an eye of a wearer, the lens element comprising:
a holder, and
a plurality of optical elements superimposed on the holder, each optical element providing simultaneously a first optical function based on a prescription of the wearer for correcting an abnormal refraction of said eye and a second optical function of not focusing an image on the retina of said eye,
   characterized in that each optical element comprises a central area and a plurality of outer areas surrounding the central area, wherein the maximal height of the central area is smaller than the maximal height of the outer areas.

Advantageously, the lens element according to the invention allows more efficiently correcting an abnormal refraction of an eye and slowing down the progression of an abnormal refraction of an eye. In other words, the design of the lens element optimizes the optical performances of both the first and second optical functions.

According to further embodiments which can be considered alone or in combination:
the optical elements are diffractive lenslets; and/or
the diffractive lenslets are z-Fresnel lenslets diffracting light in at least two main diffraction orders 0 and +1; and/or
the diffraction order 0 is associated with the first optical function based on a prescription of the wearer for correcting an abnormal refraction of said eye, and the second diffraction order +1 is associated with the second optical function of not focusing on the retina of the wearer; and/or
wherein the second optical function is a sphero-torical function defocusing light in front and/or behind the retina of the wearer; and/or
the second optical function is an aspherical function defocusing light in front and/or behind the retina of the wearer; and/or
the π-Fresnel lenslets are derived from a Fresnel processing of a fully continuous shape, for example a conic shape, a sphero-toric shape, an atoric shape, or an aspheric shape; and/or
the holder comprises a main optical center, and each optical element comprises a secondary optical center, and wherein the average mean optical power value of the second optical function of each optical element varies according to the radial distance between the secondary optical center of the optical element and the main optical center; and/or
the average mean optical power value of the second optical function increases with the radial distance from the optical center; and/or
the average mean optical power value of the second optical function decreases with the radial distance from the optical center; and/or
the lens element comprises a main optical center and each optical element comprises a secondary optical center, and, and wherein the diffraction efficiency of the two main orders of diffraction 0 and +1 of each optical element varies according to the radial distance between the secondary optical center of the optical element and the main optical center; and/or
the second optical function of not focusing an image on the retina of said eye of each optical element creates a volume of focused or defocused light at a constant distance from the retina of the eye of the wearer; and/or
the plurality of optical elements are contiguous; and/or
the plurality of optical elements are non-contiguous; and/or
the lens element further comprises a central area having a diameter greater than or equal to 4 mm and smaller than or equal to 22 mm and including a framing reference point that faces the pupil of the wearer gazing straight ahead in standard wearing conditions, said central area being free of optical elements; and/or
the plurality of optical elements cover the entire surface of the lens element; and/or
the plurality of optical elements are encapsulated between at least two substrates forming the holder of the lens element.

### BRIEF DESCRIPTION OF THE DRAWINGS

Embodiments of the invention will now be described, by way of example only, and with reference to the following drawings in which:

FIG. 1 illustrates a schematic front view of a lens element according to an embodiment of the disclosure;

FIGS. 2A to 2B illustrate schematic profile view of a lens element according to embodiments of the disclosure;

FIG. 3A illustrates a schematic front view of an optical element according to an embodiment of the disclosure;

FIG. 3B illustrates a schematic profile view of an optical element according to an embodiment of the disclosure;

FIG. 4 illustrates schematic front profile view of lens elements according to the disclosure; and

FIGS. 5A and 5B illustrate Modulation Transfer Functions of lenses elements according to the disclosure; and

FIG. 6 illustrates a schematic front view of a lens element according to an embodiment of the disclosure.

Elements in the figures are illustrated for simplicity and clarity and have not necessarily been drawn to scale. For example, the dimensions of some of the elements in the figure may be exaggerated relative to other elements to help to improve the understanding of the embodiments of the present invention.

### DETAILED DESCRIPTION

In the reminder of the description, terms like «up», «bottom», «horizontal», «vertical», «above», «below», «front», «rear» or other words indicating relative position may be used. These terms are to be understood in the wearing conditions of the optical lens.

The disclosure relates to a lens element intended to be worn in front of an eye of a wearer in specific wearing conditions, for example in standard viewing conditions.

In the context of the present disclosure, the term “optical lens” can refer to a contact lens or an optical lens or a spectacle optical lens edged to fit a specific spectacle frame or an ophthalmic lens or a progressive multifocal addition lens, or an optical device adapted to be positioned on the ophthalmic lens. The optical device may be positioned on the front or back surface of the ophthalmic lens. The optical device may be an optical patch or film. The optical device may be adapted to be removably positioned on the ophthalmic lens for example a clip configured to be clipped on a spectacle frame comprising the ophthalmic lens.

The wearing conditions are to be understood as the position of the optical lens with relation to the eye of a wearer, for example defined by a pantoscopic angle, a wrap angle, a Cornea to lens distance, and eventually any of a Pupil-cornea distance, a center of rotation of the eye (CRE) to pupil distance, a CRE to lens distance and.

The Cornea to lens distance is the distance along the visual axis of the eye in the primary position (usually taken to be the horizontal) between the cornea and the back surface of the lens; for example comprised between 8 and 16 mm, preferably 10 and 14 mm, more preferably equal to 12 mm.

The Pupil-cornea distance is the distance along the visual axis of the eye between its pupil and cornea; usually comprised between 1 and 4 mm, for example equal to 2 mm.

The CRE to pupil distance is the distance along the visual axis of the eye between its center of rotation (CRE) and cornea; for example comprised between 10 and 15 mm, preferably 11 and 12 mm, more preferably equal to 11.5 mm.

The CRE to lens Q'O distance is the distance along the visual axis of the eye in the primary position (usually taken to be the horizontal) between the CRE of the eye and the back surface of the lens, for example comprised between 20 and 30 mm, preferably 22.5 and 28 mm, more preferably equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example comprised between −25° and +5°, preferably −12° and 0°, more preferably between −10° and −6 °, for example equal to −8°, preferably equal to 0°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example comprised between −10° and +25°, preferably 0° and 10°, more preferably between 0° and +5°, for example equal to 0°.

An example of standard wearing condition may be defined by a pantoscopic angle of 8°, a Cornea to lens distance of 12 mm, a Pupil-cornea distance of 2 mm, a CRE to pupil distance of 11.5 mm, a CRE to lens distance of 25.5 mm and a wrap angle of 0°.

Another example of standard wearing condition more adapted for younger wearers may be defined by a pantoscopic angle of 0°, a Cornea to lens distance of 12 mm, a Pupil-cornea distance of 2 mm, a CRE to pupil distance of 11.5 mm, a CRE to lens distance of 25.5 mm and a wrap angle of 0°.

The lens element 10 intended to be worn in front of an eye of a wearer comprises a holder 12.

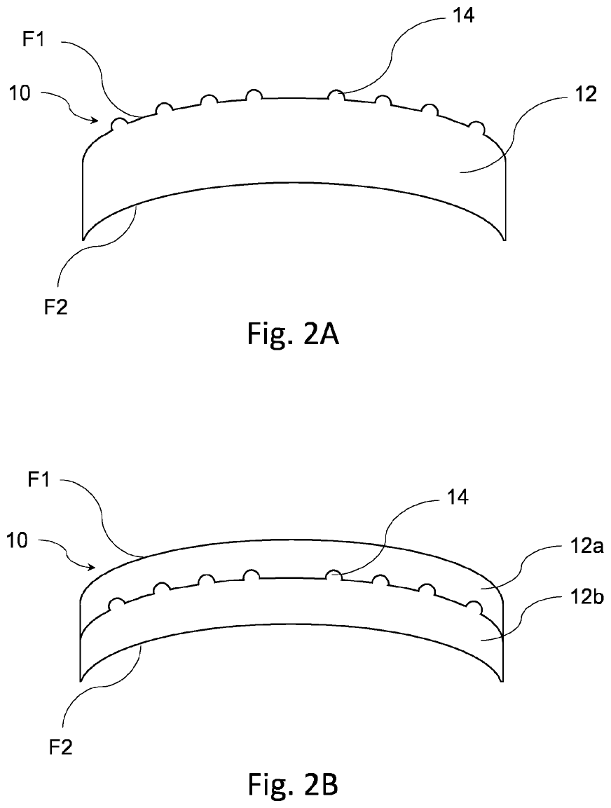

As illustrated in FIG. 2a, the holder 12 may comprise an object side surface F1 formed as a convex curved surface toward an object side. The holder may comprise an eye side surface F2 formed as a concave surface towards the eye of the wearer and opposed to the object side surface F1. Alternatively, the object side surface F1 and/or the eye side surface F2 may be any one of a plano surface, a convex surface, or a concave surface.

The holder 12 may be formed by a plurality of lens members put in close contact together. In the example illustrated in FIG. 2b, the holder comprises a first lens member 12a comprising an object side surface F1 formed as a convex curved surface toward an object side and a complementary surface opposed to the object side surface. The holder further comprises a second lens member 12b comprising an eye side surface F2 formed as a concave surface towards the eye of the wearer and a complementary surface opposed to the eye side surface. Both complementary surfaces of the first and second lens members 12a and 12b are designed to fit precisely into the other to ensure a tight and secure fit when the two lens member are brought together.

At least part, for example all, of the object side surface F1 and/or the eye side surface F2 may be covered by at least one layer of coating element. The at least one layer of coating element may comprise features selected from the group consisting of anti-scratch, anti-reflection, anti-smudge, anti-dust, UV30 filtration, blue light-filtration, anti-abrasion features. The layer of coating element may be provided using any known techniques. For example, the layer of coating may be provided using a dipping process where the optical lens simultaneously receives a layer of coating on each surface.

The holder may be made of any suitable material such as mineral material like glass, or organic material like plastic, resin. The index of refraction of the material used for the holder may be suitably selected to obtain targeted optical properties for the lens element. Preferably, the index of refraction n of the holder is comprised between 1, 3 and 1.7 when measured for a wavelength of 550 nm. For example, the index of refraction n may be smaller than or equal to, or between any two of, 1.9; 1.8; 1.75; 1.73; 1.71; 1.69; 1.67; 1.65; 1.63; 1.61; 1.59; 1.57; 1.55; 1.54; 1.53; 1.52; 1.51; 1.50; 1.49; 1.48; 1.47; 1.46; 1.45; or lower, and/or greater than or equal to, or between any two of 1.1; 1.2; 1.25; 1.3; 1.31; 1.33; 1.35; 1.37; 1.39; 1.41; 1.43; 1.45; or higher. When the holder comprises a plurality of lens members, the indices of refraction of the material of the lens members may be different. Alternatively, the indices of refraction of the material of the lens members may be identical.

The object side surface F1 and/or the eye side surface F2 of the holder may have any suitable shape, such as spherical or non-spherical. The term “spherical shape” refers to the curvature of the lens surface, which closely follows the shape of a perfect or almost perfect sphere. A spherical surface has a substantially uniform curvature over the entire surface of the lens element, which remains substantially the same in all meridians. A non-spherical surface should be understood as not being uniform over the entire surface of the lens element, with different curvatures in different meridians.

The object side surface F1 and/or the eye side surface F2 of the holder may have a toric shape. A toric surface has two principal meridians that are perpendicular to each other, often referred to as the “steep” and “flat” meridians. The curvature of the surface in these meridians is different.

The object side surface F1 and/or the eye side surface F2 of the holder may have an aspherical shape. An aspherical surface has a curvature that progressively vary over the surface of the lens element. The curvature along different meridians varies from the geometrical center of the lens element towards the periphery, for example, the curvature of the surface increases or decreases towards the peripheral part of the surface. The shape of an aspherical surface is typically described using a mathematical equation, such as a conic section or a polynomial equation.

The object side surface F1 and/or the eye side surface F2 of the holder may have progressive addition lens profile. In the sense of the disclosure, a “progressive addition lens profile surface” should be understood as a surface comprising two areas having different spherical surface, and a third areas joining the two first areas, along which the curvature value of the surface transitions from the first the second curvature values of the corresponding two areas.

Alternatively, the object side surface F1 and/or the eye side surface F2 of the holder may have a plano shape. A plano surface has no curvature over the entire surface of the lens element.

The lens element intended to be worn in front of an eye of a wearer comprises a comprises a plurality of optical elements.

As illustrated in FIGS. 2a and 2b, the plurality of optical elements 14 are superimposed on the holder 12. In the sense of the disclosure, the expression “superimposed” should be understood as located on the object side surface F1 (front surface) of the lens element and/or on the eye side surface F2 (back surface) of the lens element and/or in between the object side and eye side surfaces F1 and F2 (front and back surfaces) of the lens elements.

When the holder is formed by a plurality of lens member, the plurality of optical elements may be encapsulated within the lens element. In the sense of the invention, “being encapsulated” should be understood as being surrounded, encased, protected in, or isolated from the outside of the lens element, as if in a capsule. In the embodiment illustrated in FIG. 2b, the optical elements are disposed on the complementary surface opposed to the eye side surface F2 of the lens member 12b. However, it should be understood that the plurality of optical elements may be disposed on any of the complementary surfaces opposed to the object side and/or the eye side surfaces F1 and F2 of the lens members 12a and 12b.

Advantageously, having the optical elements encapsulated within the lens element allows protecting them. In addition, having the optical elements encapsulated allows facilitating lens surface treatments, for example the addition of coating layers such as abrasion resistance coating, UV filtration coating among others, without impacting the optical functions of the optical elements.

The plurality of optical elements may be formed on the lens element using any of the well-known manufacturing techniques of the prior art. For example, the plurality of optical elements may be engraved, imprinted, etched, or embossed directly on a surface of the lens element.

The plurality of optical elements may be made of the same material as the one of the holder on which they are superimposed. Alternatively, the optical elements and the holder may be made of different materials. For example, when the plurality of optical element are encapsulated between two lens members, the optical elements may be made of a same first material as the lens member on which they are disposed, and be different from the second material of the second lens member encapsulating said optical elements.

Each optical element is designed to simultaneously provide at least a first optical function and a second optical function.

The first and second optical functions are to be considered for a wearer wearing the lens element, for example in standard wearing conditions, and looking straight ahead at a target object, preferably located at infinity, in central vision. The eye of the wearer is preferably considered to be in an unaccommodated state when looking at an object located at infinity. However, a person of ordinary skill in the art would be able to use known accommodative response models to vary the accommodative state of the eye of the wearer according to the distance between the eye of the wearer and the object he or she is looking at.

The first and second optical functions of the optical elements may be a transparent optical function.

The first optical function of the optical elements is based on a prescription of the wearer for correcting an abnormal refraction of said eye of the wearer.

The term “prescription” is to be understood to mean a set of optical characteristics of optical power, of astigmatism, of prismatic deviation, determined by an ophthalmologist or optometrist in order to correct the vision defects of the eye, for example by means of a lens positioned in front of his eye. For example, the prescription for a myopic eye comprises the values of optical power and of astigmatism with an axis for the distance vision. The prescription may comprise an indication that the eye of the wearer has no defect and that no refractive power is to be provided to the wearer.

In other words, the optical elements are configured so that, when the wearer wearing the lens element in standard wearing conditions looks straight ahead at an object located at infinity distance, incident light emitted by said object will passing throughout an optical elements and the holder on which it is superimposed, will focus on the retina, for example on the fovea, of the eye of said wearer.

Advantageously, the first optical function allows providing good visual acuity and good visual comfort to the wearer by correcting the defect of its eye.

The second optical function of the optical elements is configured to not focus an image on the retina of the eye of the wearer.

Not focusing an image on the retina of the eye of the wearer should be understood as not creating a sharp image. In other words, the second optical function of not focusing on the retina of the plurality of optical elements provides a perturbated image, for example an image of reduced quality. When the wearer wears the lens element, for example in standard wearing conditions, at least part of the rays of light passing through the plurality of optical elements will not focus on the retina of the eye of the wearer. For example, the second optical function of the optical elements may direct incident rays of light passing through an optical element towards a focus point located in front and/or behind the retina of the eye, or create a volume of defocused light other than on the retina of the eye.

Advantageously, not focusing an image on the retina of the wearer allows creating a control signal that suppresses, reduces, or at least slows down the development and the progression of abnormal refractions, such as myopia or hyperopia, of the eye of the person wearing the lens element.

Having optical elements simultaneously having a first optical function and a second optical function allows limiting the development of an abnormal refraction, while also correcting it, thereby providing good visual acuity and visual comfort to the wearer.

The second optical function of the optical elements may be configured to create a volume of focused or defocused light at a constant distance from the retina of the eye of the wearer. For example, at least part of the optical elements may be configured to create a caustic in front of the retina of the eye of the wearer, so that every section plane where the light flux is concentrated if any, is located in front of the retina of the eye of the person and at a constant distance from the retina.

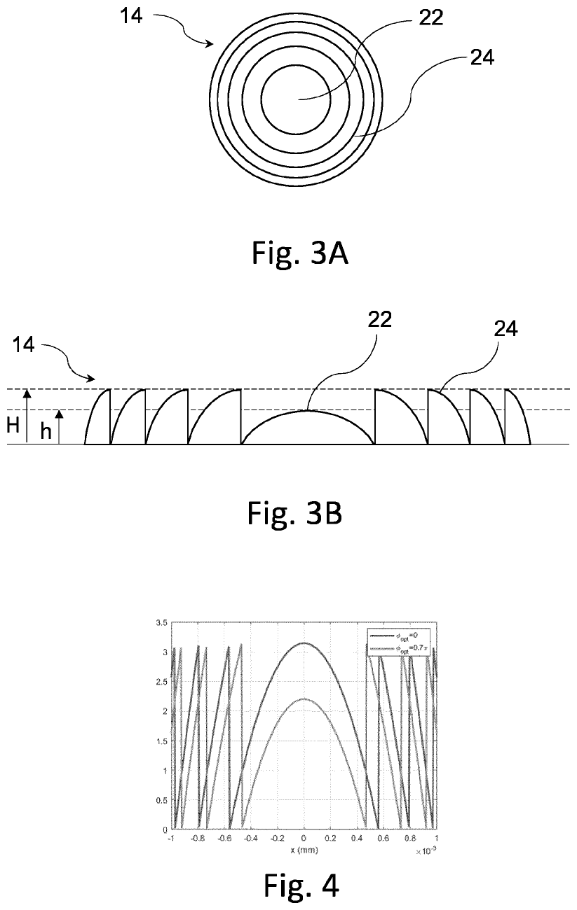

As illustrated in FIG. 3, each optical element 14 comprises a central area 22 and a plurality of outer areas 24 surrounding the central area 22.

The central area 22 and the successive outer areas 24 may have any suitable shape. In the example illustrated in FIG. 3a representing a front view of an optical element 14, the central area 22 and the outer areas 24 have an annular shape, and are organized as concentric rings. The concentric rings may be regularly spaced. According to a preferred embodiment of the disclosure, the distance between two consecutive concentric rings forming the outer areas 24 may decrease with the eccentricity from the central area. Alternatively, the central area 22 and/or the outer areas 24 may have any of an irregular shape, an oval shape, a hexagonal shape, a square shape, a triangular shape among others when observed in the front plane.

The optical elements 14 may have a contour shape circumscribed by a circle having a diameter smaller than or equal to 3.0 mm, for example smaller than or equal to 2.5 mm, preferably smaller than or equal to 2.0 mm, more preferably smaller than or equal to 1.5 mm, for example smaller than or equal to 1.0 mm. The optical elements may further be characterized by their largest inscribed circle that has a diameter greater than or equal to 0.1 mm, preferably greater than or equal to 0.2 mm, more preferably greater than or equal to 0.4 mm, even more preferably greater than or equal to 0.5 mm, for example greater than or equal to 0.6 mm. The central area 22 may have a radial size, which corresponds to size of the radius of the circle that would best fit the shape of the base of the central area, greater than or equal to, or between any two of 0.01 mm, 0.02 mm, 0.03 mm, 0.04 mm, 0.05 mm, 0.06 mm, 0.07 mm, 0.08 mm, 0.09 mm, 0.1 mm, 0.2 mm, 0.4 mm, 0.5 mm, 1.0 mm, 1.5 mm, 1,6 mm, 1.7 mm, 1.8 mm, 1.9 mm, or 2.0 mm.

When observed in the sagittal plane, the optical element is formed by a series of successive grooves or ridges. In the example illustrated in FIG. 3b representing a section along a transversal or sagittal plane of the lens element, the optical element 14 comprises a series of concentric grooves and ridges, regularly and symmetrically organized around the geometrical center of said optical element. The pitch of the grooves or ridges may be constant between the different outer areas 24. Alternatively, the pitch of the grooves or ridges of the outer areas 24 may vary. For example, the pitch of the grooves or ridges of the outer areas 24 may decrease along the section, from the central area 22 towards the periphery of said section.

Preferably, the maximal height h of the central area 22 is smaller than the maximal height H of the outer areas 24. In the sense of the disclosure, the maximal height of the optical element, is defined as the vertical distance from the base of the optical element to its highest point or apex. The base of the optical element may correspond to the tangent plane that best fits the surface of the holder on which it is superimposed. Typically, the height of the optical element is measured in the orthogonal reference system comprising the tangent plane and the normal axis extending from said tangent plane and corresponds to the size of the normal axis extending from the base of the optical element or the tangent plane, up to the surface of the optical element. When the optical element is encapsulated between two lens members, the base of the optical element may correspond to the tangent plane that best fits the surface of the lens member on which it is superimposed.

For example, the maximal height of the central area may be greater than or equal to, or between any two of 0.01 mm, 0.02 mm, 0.04 mm, 0.05 mm, 0.1 mm, 0.2 mm, 0.4 mm, 0.5 mm, 1.0 mm, 1.5 mm, 2.0 mm, 2.5 mm or 3.0 mm.

The term “heigh” has been used to clarify the specification. However, in the context of the disclosure, the “heigh” of an optical structure may refer to its optical thickness which is defined by the following equation: Δn×e, with e the thickness of the optical structure throughout which light passes, and An the difference of refractive index of the material along the path of light.

Advantageously, it allows improving the optical performances of the lens element. In other words, a lens element according to the disclosure will provide better visual acuity and visual comfort to the wearer.

FIG. 4 illustrates the profiles of two examples of optical elements, a first optical element of a lens element of the prior art having a central area and outers areas, all having the same maximal height, and an optical element according to the disclosure having a central area with a lower maximal height than the maximal height of the outer areas. In both examples, the optical element has a square surface of 2.0 mm×2.0 mm, and comprise a first optical function of 0 D and a second optical function of 3.5 D.

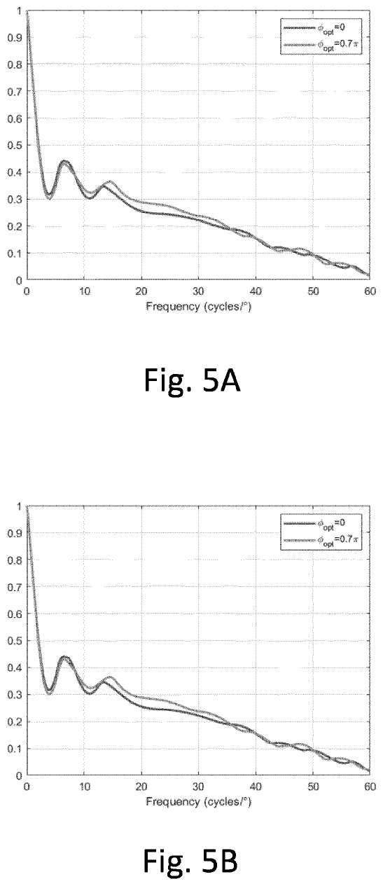

FIG. 5A compares the optical performances of the first optical function (0 D) of the lens element of the prior art and the lens element according to the disclosure. Similarly, FIG. 5B compares the optical performances of the second optical function (+3.5 D) of the lens element of the prior art and the lens element according to the disclosure. In both examples, the optical performances are determined measuring the modulation transfer function for a wavelength of 550 nm.

The modulation transfer function (MTF) is a well-known quantitative measurement that describes the imaging performance of an optical system. The MTF characterizes an optical system's ability to reproduce fine details and resolve spatial frequencies. It measures the contrast transfer as a function of the spatial frequency of the object being imaged and provides information about the optical system's resolving power and the amount of contrast degradation for different spatial frequencies. Typically, a high MTF value indicates that the optical system can effectively reproduce high-frequency details with minimal contrast loss, resulting in a sharp and detailed image. Conversely, a low MTF value indicates a reduction in contrast and loss of fine details as the spatial frequency increases.

The modulation transfer function may be determined by measuring the 3D surface of the lens element, determining a 2D representation of optical path differences of a light beam arriving normal to the lens element, determining the point spread function over a pupil aperture, for example having a diameter comprised between 2 mm and 8 mm, preferably between 3 mm and 6 mm, for example 4 mm, and centered at 6.6 mm from the optical center of the lens element, and determining the modulation transfer function over said pupil by a Fourier transform operation.

FIG. 5a shows that the MTF value measure between 20 and 30 cycles per degree for a wavelength of 550 nm is higher for the lens element of the disclosure with a central area having a smaller maximal height than the maximal height of the outer areas, when compared with the lens element of the prior. In other words, the first optical function of the lens element according to the disclosure has better performances, and thus provides a better visual acuity, than the first optical function of the lens element of the prior art.

Similarly, FIG. 5b shows that the MTF value measure between 20 and 30 cycles per degree for a wavelength of 550 nm is higher for the lens element of the disclosure with a central area having a smaller maximal height than the maximal height of the outer areas, when compared with the lens element of the prior. Thus, the optical performances of the second optical function of the lens element of the disclosure are higher than the optical performances of the second optical function of the lens element of the prior art.

The plurality of optical elements 14 of the lens element 10 may be a plurality of lenslets.

Lenslets have a contour shape circumscribed by a circle having a diameter smaller than or equal to 3.0 mm, for example smaller than or equal to 2.5 mm, preferably smaller than or equal to 2.0 mm, more preferably smaller than or equal to 1.5 mm, for example smaller than or equal to 1.0 mm. The lenslets may further be characterized by their largest inscribed circle that has a diameter greater than or equal to 0.1 mm, preferably greater than or equal to 0.2 mm, more preferably greater than or equal to 0.4 mm, even more preferably greater than or equal to 0.5 mm, for example greater than or equal to 0.6 mm.

At least part, for example more than 50%, preferably all, of the optical elements of the lens element may be refractive optical elements.

The first optical function and/or the second optical function of the plurality of refractive optical elements may be designed to refract or bend at least part of incident light passing through it. For example, refractive optical elements can manipulate the direction of the incident light beam into a single focused point. Alternatively, refractive optical elements can be used to modify the direction of each incident light rays towards different focus points, thereby creating a blur or volume of non-focused light, for example in front and/or behind the retina of the wearer.

The refractive optical elements may be non-spherical optical elements. In the sense of the disclosure, the term “non-spherical” should be understood as not having a single focus point. Non-spherical optical elements do not have a constant curvature and refractive power over their surface, and should be opposed to spherical optical elements which have a constant refractive power over their surface.

The optical elements may be torical optical elements comprising a cylindrical power.

The optical elements may be a multifocal refractive optical elements. In the sense of the disclosure, “multifocal refractive optical elements” includes bifocals (with two focal powers), trifocals (with three focal powers), progressive addition lenses, with continuously varying focal power, for example aspherical optical elements.

The optical elements may be aspherical optical elements. In the sense of the disclosure, aspherical optical elements have a continuous power evolution over their surface. For example, the refractive power may increase, or decrease, from a geometrical or optical center to the periphery of the optical element.

At least part, for example more than 50%, preferably all, of the optical elements of the lens element may be diffractive optical elements.

The plurality of diffractive optical elements are designed to diffract or bend light in specific ways. For example, diffractive optical elements can control the phase and amplitude of the diffracted light, thereby modifying the shape of the incident light beam into a single focused point. Alternatively, diffractive microstructures can be used to split a single incident beam of light into multiple beams, redirecting them along different paths, thereby creating a blur or volume of non-focused light.

The diffractive optical elements may be π-Fresnel lenslets. In the sense of the disclosure π-Fresnel lenslets are Fresnel lenslets whose phase function ψ(r) has π phase jumps at the nominal wavelength λ₀, as opposed to unifocal Fresnel lenses whose phase jumps are multiple values of 2π. A π-Fresnel lenslet diffracts light mainly in two diffraction orders (order 0 and +1), for example associated to dioptric powers P(λ₀)=0 δ and a positive one P(λ₀)=3 δ, with λ₀=550 nm.

Advantageously, π-Fresnel lenslets allow diffracting incident light towards two main different planes, thereby providing two different optical functions.

Preferably, the diffraction order 0 of the π-Fresnel lenslets is associated with the first optical function of the optical element based on a prescription of the wearer for correcting an abnormal refraction of an eye of said wearer, and the second diffraction order +1 of the π-Fresnel lenslets is associated with the second optical function of the optical element of not focusing on the retina of the wearer.

Advantageously, having I-Fresnel lenslets comprising a central area whose maximal height is lower than the maximal height of the outer areas allows improving the optical performances, for example the Modulation Transfer Function (MTF) value, of both the first and second optical functions, without affecting the diffraction efficiency of the two main orders of diffraction 0 and +1 nor the optical powers of the first and second optical functions.

Typically, Fresnel structures are obtained by folding a quadratic phase function φ₀ on itself, generating a structure comprising a plurality of concentric rings having the same maximal height. By applying an offset φₒₚₜ to the phase function φ₀ before being folded, the Fresnel structure generated will have a central area with a lower maximal height compared to the concentric rings. The value of the offset φₒₚₜ to be applied to the phase function po can be optimized to obtain π-Fresnel lenslets with optimized central area height that provide improved optical performances. In the examples of the disclosure illustrated in FIGS. 5A and 5B, it was determined that a value of offset φₒₚₜ=0.77 would provide the best MTF values between 20 and 30 cycles per degree for a wavelength of 550 nm.

The π-Fresnel lenslets may be derived from a Fresnel processing of a fully continuous shape, for example a conic shape, a sphero-toric shape, an atoric shape, or an aspheric shape.

The first optical function based on a prescription adapted for correcting an abnormal refraction of an eye of the wearer may be a spherical function. By “spherical function” it should be understood that the refractive power is substantially constant over the entire element.

Alternatively, the first optical function may be a non-spherical function. In the sense of the disclosure, the term “non-spherical function” should be understood as not having a single focus point. A non-spherical function is characterized by a variation of curvature and refractive power over the surface of the element, and should be opposed to spherical function which focus light on a single function point. For example, the first optical function may be a toric function, an atoric function, a multifocal function, a progressive function, or an aspherical function.

The second optical function of not focusing an image on the retina of the eye of the wearer may be a spherical function.

Alternatively, the second optical function of not focusing an image on the retina of the eye of the wearer may be a non-spherical function.

For example, the second optical function may be a sphero-torical function defocusing light in front and/or behind the retina of the wearer. Typically, a sphero-torical function is characterized by a first refractive power and a cylinder.

According to another embodiment of the disclosure, the second optical function may be an aspherical optical function defocusing light in front and/or behind the retina of the wearer. Typically, an aspherical optical function is characterized by a continuous refractive power evolution over the surface of the element. For example, the refractive power may increase, or decrease, from a geometrical or optical center to the periphery of the element.

The holder of the lens element may comprise a main optical center. For example, the main optical center may correspond to the geometrical center of the lens element. Similarly, each optical element may comprise a secondary optical center. The secondary optical center of an optical element may correspond to its geometrical center.

The optical elements may be designed so that the average mean power value of the second optical function of not focusing on the retina of each optical element varies according to the radial distance between their secondary optical center and the main optical center of the holder.

Advantageously, having the average mean optical power value of the secondary optical function of the optical elements varying according to the radial distance allows varying the defocus and by extension the intensity of the myopia control signal which lead to a better control of the progression of the abnormal refraction of the eye.

For example, the average mean optical power value of the second optical function may increase with the radial distance from the main optical center of the holder. In other words, the average mean optical power value of the second optical function of an optical element located close to the main optical center of the holder may be higher than the average mean optical power value of the second optical function of an optical element located close to the periphery of the holder.

Alternatively, the average mean optical power value of the second optical function may decrease with the radial distance from the main optical center of the holder. In other words, the average mean optical power value of the second optical function of an optical element located close to the main optical center of the holder may be lower than the average mean optical power value of the second optical function of an optical element located close to the periphery of the holder.

According to another embodiment of the disclosure, the optical elements may be designed so that the average mean optical power value of the second optical function of the optical elements may increase with the radial distance from the main optical center of the holder to a threshold distance, and further decrease with the radial distance past the threshold distance. For example, for a radial distance between the main optical center of the holder and the secondary optical center of an optical element smaller than or equal to 1.0 cm, preferably 2.0 cm, for example 3.0 cm, the average mean optical power value of the secondary optical function of the optical elements increases, and for a radial greater than 1.0 cm, preferably 2.0 cm, for example 3.0 cm, the average mean optical power value of the secondary optical function of the optical elements decreases.

For optical elements being π-Fresnel lenslets, the diffraction efficiency of the two main orders of diffraction 0 and +1 of each π-Fresnel lenslet may vary according to the radial distance between their secondary optical center and the main optical center of the holder.

Similarly to the average mean optical power value of the second optical function of the optical element, the diffraction efficiency of the two main orders of diffraction 0 and +1 of each π-Fresnel lenslet may increase, decrease or increase and further decrease according to the radial distance between their secondary optical center and the main optical center of the holder.

Advantageously, having the diffraction efficiency of the two main orders of diffraction 0 and +1 of each π-Fresnel lenslet varying according to the radial distance allows tuning the balance between the first optical function correcting an abnormal refraction of the eye and the secondary optical function slowing down the progression of said abnormal refraction of the eye. In other words, it allows providing the most adapted myopia control signal while maintaining an optimal visual acuity or visual comfort for the wearer.

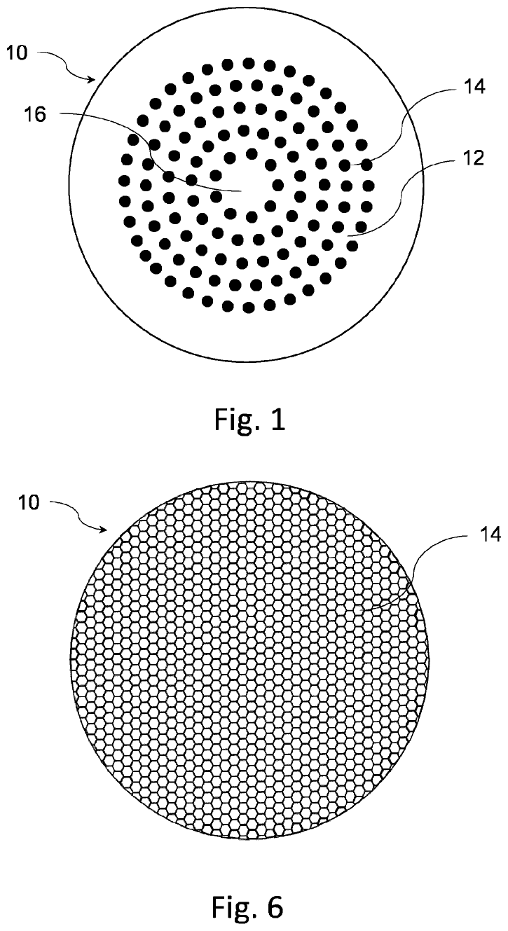

As represented in FIG. 1, at least part, for example more than 50%, preferably all, of the optical elements 14 may be contiguous.

As represented in FIG. 6, at least part, for example more than 50%, preferably all, of the optical elements 14 may be non-contiguous.

In the sense of the disclosure, two optical elements disposed on a surface are contiguous if there is a path supported by said surface that links the two optical elements and if along said path one does not reach the basis surface on which the lenslets are superimposed.

When the surface on which the at least two optical elements are superimposed is spherical, the basis surface corresponds to said spherical surface. In other words, two optical elements superimposed on a spherical surface are contiguous if there is a path supported by said spherical surface and linking them and if along said path one may not reach the spherical surface.

When the surface on which the at least two optical elements are superimposed is non-spherical, the basis surface corresponds to the local spherical surface that best fits said non-spherical surface. In other words, two optical elements superimposed on a non-spherical surface are contiguous if there is a path supported by said non-spherical surface and linking them and if along said path one may not reach the spherical surface that best fit the non-spherical surface.

The density of optical elements on the lens element is comprised between 20% and 100%, for example between 30% and 80% or between 40 and 60%. For example, for every circular zone having a radius comprised between 2 and 4 mm comprising a geometrical center located at a distance of the main optical center of the lens element greater or equal to said radius +5 mm, the ratio between the sum of areas of the parts of lenslets located inside said circular zone and the area of said circular zone is comprised between 20% and 100%, preferably between 30% and 80%, for example between 40% and 60%.

As illustrated in FIG. 1, the lens element 10 may comprise a central area 16 having a diameter greater than or equal to 2.0 mm, preferably 3.0 mm, more preferably 4.0 mm and smaller than or equal to 40 mm, preferably 30 mm, more preferably 22 mm, free of optical elements 14. The centra area including a framing reference point that faces the pupil of the wearer gazing straight ahead in standard wearing conditions.

As illustrated in FIG. 6, the optical elements 14 may be organized over the entire surface of the lens element 10. In other words, the ratio between the sum of the projected areas of the lens element covered by lenslets and the total area is equal to 1. When the optical elements are encapsulated within the lens element, for example between two lens members, the optical elements may be organized over the entire surface of at least one of the lens members.

The optical elements may be positioned on a structured mesh, for example a squared mesh or a hexagonal mesh or a triangle mesh or an octagonal mesh.

As illustrated in FIG. 1, the optical elements may be organized in a plurality of concentric rings centered on an optical center and/or a geometric center of the surface of the lens member on which the lenslets are superimposed.

The radial distance between two successive concentric rings of optical element may be identical. Alternatively, the radial distance between two successive concentric rings of optical elements may vary, for example increase or decrease. Preferably, the distance between two successive concentric rings of optical elements is greater than or equal to 1.00 mm, preferably 2.0 mm, more preferably 4.0 mm.

Advantageously, such organization of optical elements on the lens elements allows providing a strong myopia control signal while maintaining optimal visual acuity or vision comfort for the wearer.

Unless specifically stated otherwise, as apparent from the following discussions, it is appreciated that throughout the specification discussions utilizing terms such as “computing”, “calculating”, “generating”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer or Digital Signal Processor (“DSP”) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Many further modifications and variations will be apparent to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. A lens element intended to be worn in front of an eye of a wearer, the lens element comprising:
a holder, and
a plurality of optical elements superimposed on the holder, each optical element providing simultaneously a first optical function based on a prescription of the wearer for correcting an abnormal refraction of said eye and a second optical function of not focusing an image on a retina of said eye,
wherein each optical element comprises a central area and a plurality of outer areas surrounding the central area, wherein the maximal height of the central area is smaller than the maximal height of the outer areas.

2. The lens element according to claim 1, wherein the optical elements are diffractive lenslets.

3. The lens element according to claim 2, wherein the diffractive lenslets are π-Fresnel lenslets diffracting light in at least two main diffraction orders 0 and +1.

4. The lens element according to claim 3, wherein the diffraction order 0 is associated with the first optical function based on a prescription of the wearer for correcting an abnormal refraction of said eye, and a second diffraction order +1 is associated with the second optical function of not focusing on the retina of the wearer.

5. The lens element according to claim 1, wherein the second optical function is a sphero-torical function defocusing light in front of the retina of the wearer.

6. The lens element according to claim 1, wherein the second optical function is an aspherical function defocusing light in front of the retina of the wearer.

7. The lens element according to claim 3, wherein the π-Fresnel lenslets are derived from a Fresnel processing of a fully continuous shape, for example a conic shape, a sphero-toric shape, an atoric shape, or an aspheric shape.

8. The lens element according to claim 1, wherein the holder comprises a main optical center, and each optical element comprises a secondary optical center, and wherein an average mean optical power value of the second optical function of each optical element varies according to a radial distance between the secondary optical center of the optical element and the main optical center.

9. The lens element according to claim 8, wherein the average mean optical power value of the second optical function increases with the radial distance from the main optical center.

10. The lens element according to claim 8, wherein the average mean optical power value of the second optical function decreases with the radial distance from the optical center.

11. The lens element according to claim 3, wherein the lens element comprises a main optical center and each optical element comprises a secondary optical center, and, and wherein diffraction efficiency of the two main orders of diffraction 0 and +1 of each optical element varies according to a radial distance between the secondary optical center of the optical element and the main optical center.

12. The lens element according to claim 1, wherein the second optical function of not focusing an image on the retina of said eye of each optical element creates a volume of focused or defocused light at a constant distance from the retina of the eye of the wearer.

13. The lens element according to claim 1, further comprising a central area having a diameter greater than or equal to 4 mm and smaller than or equal to 22 mm and including a framing reference point that faces a pupil of the wearer gazing straight ahead in standard wearing conditions, said central area being free of optical elements.

14. The lens element according to claim 1, wherein the plurality of optical elements cover an entire surface of the lens element.

15. The lens element according to claim 1, wherein the plurality of optical elements are encapsulated between at least two members forming the holder of the lens element.

16. The lens element according to claim 1, wherein the second optical function is a sphero-torical function defocusing light behind the retina of the wearer.

17. The lens element according to claim 1, wherein the second optical function is an aspherical function defocusing light behind the retina of the wearer.

18. The lens element according to claim 2, wherein the second optical function is a sphero-torical function defocusing light in front of the retina of the wearer.

19. The lens element according to claim 2, wherein the second optical function is an aspherical function defocusing light in front of the retina of the wearer.
